(19) United States
(12) Patent Application Publication
(10) Pub. No.: US 2018/0065077 A1
(43) Pub. Date: Mar. 8, 2018

(54) CROSS-LINKED MACROPOROUS POLYMER USED FOR SELECTIVE REMOVAL OF HYDROGEN SULFIDE FROM A GAS STREAM

(71) Applicant: Dow Global Technologies LLC, Midland, MI (US)

(72) Inventors: Runyu Tan, Richwood, TX (US); H. Robert Goltz, Midland, MI (US); Gerardo Padilla, Lake Jackson, TX (US); Ajay N. Badhwar, Houston, TX (US)

(73) Assignee: Dow Global Technologies LLC, Midland, MI (US)

(21) Appl. No.: 15/551,323

(22) PCT Filed: Apr. 4, 2016
(86) PCT No.: PCT/US2016/025821

§ 371 Date: Aug. 16, 2017

Related U.S. Application Data
(60) Provisional application No. 62/148,797, filed on Apr. 17, 2015.

(51) Int. Cl. B01D 53/02; B01J 20/26; B01J 20/28; B01J 20/34; C10L 3/10; C08L 25/16; C08L 25/06

(52) U.S. Cl. CPC B01D 53/02; B01D 2259/40094; B01J 20/28057; B01J 20/28069; B01J 20/28078; B01J 20/3425; B01J 20/3441; C10L 3/103; C08L 25/16; C08L 25/06; B01D 2253/202; B01D 2253/306; B01D 2253/308; B01D 2256/245; B01D 2257/304; B01D 2259/40086; B01D 2259/4009; B01J 20/267

(57) ABSTRACT

A process is disclosed for the removal of hydrogen sulfide (H2S) from natural. This process provides for passing a natural gas feedstream comprising H2S though a regenerable adsorbent media which adsorbs H2S to provide an H2S-lean natural gas product and H2S. The regenerable adsorbent media of the present invention is a cross-linked macroporous polymeric adsorbent media

### FIELD OF THE INVENTION

The present invention relates generally to adsorbents useful for the extraction of acid gases from gas well streams. More specifically, the invention relates to a cross-linked macroporous polymer adsorbent and method for the removal of hydrogen sulfide gas from a natural gas stream.

### BACKGROUND OF THE INVENTION

Fluid streams derived from natural gas reservoirs, petroleum or coal, often contain a significant amount of acid gases, for example carbon dioxide (CO₂), hydrogen sulfide (H₂S), sulfur dioxide (SO₂), carbon disulfide (CS₂), hydrogen cyanide (HCN), carbonyl sulfide (COS), or mercaptans as impurities. These fluid streams may be gas, hydrocarbon gases from shale pyrolysis, synthesis gas, and the like or liquids such as liquefied petroleum gas (LPG) and natural gas liquids (NGL).

In natural gas processing, it is often desirable to remove sulfur compounds from the feedstream in order to satisfy some requirement, for example natural gas pipeline H₂S concentration limits are typically set at or less than 4 parts per million (ppm).

Various compositions and processes for removal of acid gasses are known and described in the literature. Depending on the flow rate of the gas and the H₂S concentration in the gas stream, different technologies have been applied in H₂S removal for optimized economics. Conventional gas resources typically have very large gas flow rates (e.g., greater than 500 million standard cubic feet per day (MMSCFD)), in which cases liquid alkanolamine units are used. Typically, the aqueous amine solution contacts the gaseous mixture comprising the acidic gases counter currently at low temperature or high pressure in an absorber tower. The overall H₂S treating cost is very low (a few cents per pound of sulfur removal) due to the economy of scale, however, such amine treating units usually require large capital expense and operational expense.

Recently, unconventional resources, such as those from shale, have emerged. These gas resources typically have small gas flow (e.g., less than 100 MMSCFD) and contain relatively low concentration of H₂S (e.g., less than 2000 ppm) and low concentration of CO₂ (e.g. less than 2 percent).

Activated carbon has been used for acid gas removal in the hydrocarbon stream but it is not selective. The selective removal of H₂S over CO₂ and other components is desirable since it will reduce the overall adsorption unit and also make it easier to deal with the concentrated H₂S stream.

One approach to selectively removing H₂S in such applications has been the use of disposable H₂S scavengers (liquid triazine or iron sponge) because of their low capital expense and selectivity towards H₂S. However, the overall sulfur treating cost is relatively high (more than $10 per pound of sulfur removal) because of the excessive scavenger consumption. They also create hazardous waste requiring special disposing procedure. Caustic treating is also known in the industry but due to removal of all acidic components it is reserved for H₂S and mercaptan removal where there is a low level of H₂S or where there are no other options.

Zinc oxide has also been used for removing sulfur compounds from hydrocarbon streams. However, its high cost and substantial regeneration costs make it generally uneconomical to treat hydrocarbon streams containing an appreciable amount of sulfur compound impurities on a volume basis. So too, the use of zinc oxide and other chemisorption material similar to it disadvantageously generally require the additional energy expenditure of having to heat the sulfur containing fluid stream prior to its being contacted with the stream in order to obtain a desirable sulfur compound loading characteristic.

Selective physical adsorption of sulfur impurities is also known. As used herein, a “physical adsorbent” is an adsorbent which does not chemically react with the impurities that it removes. Both liquid phase and vapor phase processes have been developed. One such approach comprises passing a sulfur-containing hydrocarbon stream through a bed of crystalline zeolitic molecular sieves or a bed of a molecular sieve adsorbent having a pore size large enough to adsorb the sulfur impurities, recovering the non-adsorbed effluent hydrocarbon until a desired degree of loading of the adsorbent with sulfur-containing impurities is obtained, and thereafter purging the adsorbent mass of hydrocarbon and regenerating the adsorbent by desorbing the sulfur-containing compounds therefrom.

Conventionally, the adsorbent regenerating operation is a thermal swing or combined thermal and pressure swing-type operation in which the heat input is supplied by a hot gas substantially inert toward the hydrocarbons, the molecular sieve adsorbents and the sulfur-containing adsorbate. When treating a hydrocarbon in the liquid phase, such as propane, butane or liquefied petroleum gas (LPG), natural gas is ideally suited for use in purging and adsorbent regeneration, provided that it can subsequently be utilized in situ as a fuel wherein it constitutes an economic balance against its relatively high cost. Frequently, however, the sweetening operation requires more natural gas for thermal-swing regeneration than can advantageously be consumed as fuel, and therefore, constitutes an inadequacy of the regeneration gas. The result is a serious impediment to successful design and operation of sweetening processes, especially when desulfurization is carried out at a location remote from the refinery, as is frequently the case.

But even when treating a hydrocarbon in the gaseous phase with a physical adsorbent such as crystalline zeolitic molecular sieves and/or molecular sieves, a purge gas must still be provided to regenerate the sulfur-compound laden adsorbent, involving the same disadvantages noted above when using a liquid phase hydrocarbon stream. Generally, a product slip-stream from an adsorbent bed in the adsorption mode is utilized as the desorption gas for regenerating a used bed. The utilization of this product gas for regeneration purposes during the entire adsorption cycle disadvantageously reduces the final product yield. Moreover, it is generally difficult to get complete sulfur-compound removal when utilizing such a physical adsorbent.

There is a need for regenerable adsorbent (solid-gas contact) for H₂S separation from a natural gas stream which process is more economical and efficient than the prior art techniques discussed above.

### SUMMARY OF THE INVENTION

The present invention is a process for removing, preferably selectively removing, hydrogen sulfide (H₂S) from a natural gas feedstream comprising H₂S and optional one or more impurity, comprising the steps of:
(a) providing an adsorbent bed comprising a cross-linked macroporous polymeric adsorbent media, wherein said adsorbent media adsorbs H₂S;
(b) passing the natural gas feedstream through cross-linked macroporous polymeric adsorbent bed to provide a H₂S-lean natural gas stream and a hydrogen sulfide-loaded cross-linked macroporous polymeric adsorbent media;
(c) further treating, recovering, transporting, liquefying, or flaring the H₂S-lean natural gas stream,
(d) regenerating the loaded cross-linked macroporous polymeric adsorbent media for reuse by desorbing the adsorbed H₂S, and
(e) discharging the H₂S to be collected, flared, converted to elemental sulfur, reinjected, or converted to sulfuric acid.

One embodiment of the present invention is the process disclosed herein above wherein the cross-linked macroporous polymeric adsorbent is a polymer of a monovinyl aromatic monomer crosslinked with a polyvinylidene aromatic compound, preferably the monovinyl aromatic monomer comprises from 92% to 99.25% by weight of said polymer, and said polyvinylidene aromatic compound comprises from 0.75% to 8% by weight of said polymer.

Another embodiment of the present invention is the process disclosed herein above wherein the cross-linked macroporous polymeric adsorbent is a polymer of a member selected from one or more of the group consisting of styrene, vinylbenzene, vinyltoluene, ethylstyrene, divinylbenzene, and t-butylstyrene; and is crosslinked with a member selected from the group consisting of divinylbenzene, trivinylbenzene, and ethylene glycol dimethacrylate, preferably a polymer of a member selected from the group consisting of styrene, vinylbenzene, vinyltoluene, ethylstyrene, and t-butylstyrene, more preferably styrene; and is crosslinked with a member selected from the group consisting of divinylbenzene, trivinylbenzene, and ethylene glycol dimethacrylate, more preferably divinylbenzene; and preferably the macroporous resin has a total porosity of from 0.5 to 1.5 cc/g, a surface area of from 150 to 2100 m²/g as measured by nitrogen adsorption, and an average pore diameter of from 10 Angstroms to 100 Angstroms.

One embodiment of the present invention is the process disclosed herein above wherein the regeneration of the loaded adsorbent is achieved by using heated gas and/or a radiant heat contact exchanger, preferably the regeneration of the loaded adsorbent media is achieved by a using a pressure swing adsorption (PSA) process, a temperature swing adsorption (TSA) process, or a combination thereof, more preferably the regeneration of the loaded adsorbent media is achieved by a using a microwave heating system.

In another embodiment of the present invention, the process disclosed herein above is continuous.

### BRIEF DESCRIPTION OF THE DRAWINGS

FIG. 1 is a schematic of a natural gas adsorption and regeneration process according to the present invention.

FIG. 2 shows breakthrough curves of a cross-linked macroporous polymeric adsorbent media of the present invention for N₂ comprising varying levels of H₂S and CO₂.

### DETAILED DESCRIPTION OF THE PREFERRED EMBODIMENTS

Raw natural gas comes from three types of wells: oil wells, gas wells, and condensate wells. Natural gas that comes from oil wells is typically termed “associated gas”. This gas can exist separate from oil in the formation (free gas), or dissolved in the crude oil (dissolved gas). Natural gas from gas and condensate wells, in which there is little or no crude oil, is termed “non-associated gas”. Gas wells typically produce raw natural gas by itself, while condensate wells produce free natural gas along with a semi-liquid hydrocarbon condensate. Whatever the source of the natural gas, once separated from crude oil (if present) it commonly exists as methane in mixtures with other hydrocarbons; principally ethane, propane, butane, and pentanes and to a lesser extent heavier hydrocarbons.

Raw natural gas and sometimes treated natural gas often contain a significant amount of impurities, such as water or acid gases, for example carbon dioxide (CO₂), hydrogen sulfide (H₂S), sulfur dioxide (SO₂), carbon disulfide (CS₂), hydrogen cyanide (HCN), carbonyl sulfide (COS), or mercaptans as impurities. The term “natural gas feedstream” as used in the process of the present invention includes any natural gas source, raw or raw natural gas that has been treated one or more times to remove water and/or other impurities.

Suitable adsorbents are solids having a microscopic structure. The internal surface of such adsorbents is preferably between 100 to 2000 m²/g, more preferably between 500 to 1500 m²/g, and even more preferably 1000 to 1300 m²/g. The nature of the internal surface of the adsorbent in the adsorbent bed is such that C₂ and heavier hydrocarbons are adsorbed. Suitable adsorbent media include materials based on silica, silica gel, alumina or silica-alumina, zeolites, activated carbon, polymer supported silver chloride, copper-containing resins. Most preferred adsorbent media is a porous cross-linked polymeric adsorbent or a partially pyrolized macroporous polymer. Preferably, the internal surface of the adsorbent is non-polar.

In one embodiment, the present invention is the use of an adsorbent media to extract H₂S from a natural gas stream comprising H₂S and optionally one or more impurity. The mechanism by which the macroporous polymeric adsorbent extracts the H₂S from the natural gas stream is a combination of adsorption and absorption; the dominating mechanism at least is believed to be adsorption. Accordingly, the terms “adsorption” and “adsorbent” are used throughout this specification, although this is done primarily for convenience. The invention is not considered to be limited to any particular mechanism.

When an adsorbent media has adsorbed any amount of H₂S it is referred to as “loaded”. Loaded includes a range of adsorbance from a low level of H₂S up to and including saturation with adsorbed H₂S.

The term “macroporous” is used in the art interchangeably with “macroreticular” and refers in general to pores with diameters of about 500 Å or greater. “Mesopores” are characterized as pores of between 50 Å and larger but less than 500 Å. “Micropores” are characterized as pores of less than 50 Å. The engineered distribution of these types of pores gives rise to the desired properties of high adsorption capacity for H₂S and ease of desorption of H₂S under convenient/practical chemical engineering process modifications (increase in temperature or reduced pressure [vacuum]). The process giving rise to the distribution of micropores, mesopores and macropores can be achieved in various ways, including forming the polymer in the presence of an inert diluent or other porogen to cause phase separation and formation of micropores by post cross-linking.

In one embodiment, the adsorbent media of the present invention is a macroporous polymeric adsorbent of the present invention is a post cross-linked polymeric synthetic adsorbents engineered to have high surface area, high pore volume and high adsorption capacities as well as an engineered distribution of macropores, mesopores and micropores.

Preferably, the macroporous polymeric adsorbent of the present invention is hypercrosslinked and/or methylene bridged having the following characteristics: a BET surface area of equal to or greater than 500 m²/g and preferably equal to or greater than 1,000 m²/g, and having a particle size of 300 microns to 1500 microns, preferably 500 to 1200 microns.

Examples of monomers that can be polymerized to form macroporous polymeric adsorbents useful are styrene, alkylstyrenes, halostyrenes, haloalkylstyrenes, vinylphenols, vinylbenzyl alcohols, vinylbenzyl halides, and vinylnaphthalenes. Included among the substituted styrenes are ortho-, meta-, and para-substituted compounds. Specific examples are styrene, vinyltoluene, ethylstyrene, t-butylstyrene, and vinyl benzyl chloride, including ortho-, meta-, and para-isomers of any such monomer whose molecular structure permits this type of isomerization. Further examples of monomers are polyfunctional compounds. One preferred class is polyvinylidene compounds, examples of which are divinylbenzene, trivinylbenzene, ethylene glycol dimethacrylate, divinylsulfide and divinylpyridine. Preferred polyvinylidene compounds are di- and trivinyl aromatic compounds. Polyfunctional compounds can also be used as crosslinkers for the monomers of the first group.

In one embodiment, the macroporous polymeric adsorbent comprises divinylbenzene wherein the divinylbenzene may comprise ethyl styrene. If ethyl styrene is present, preferably it is present in an amount of equal to or less than 40 percent, more preferably equal to or less than 20 percent.

One preferred method of preparing the polymeric adsorbent is by swelling the polymer with a swelling agent, then crosslinking the polymer in the swollen state, either as the sole crosslinking reaction or as in addition to crosslinking performed prior to swelling. When a swelling agent is used, any pre-swelling crosslinking reaction will be performed with sufficient crosslinker to cause the polymer to swell when contacted with the swelling agent rather than to dissolve in the agent. The degree of crosslinking, regardless of the stage at which it is performed, will also affect the porosity of the polymer, and can be varied to achieve a particular porosity. Given these variations, the proportion of crosslinker can vary widely, and the invention is not restricted to particular ranges. Accordingly, the crosslinker can range from about 0.25% of the polymer to about 45%. Best results are generally obtained with about 0.75% to about 8% crosslinker relative to the polymer, the remaining (noncrosslinking) monomer constituting from about 92% to about 99.25% (all percentages are by weight).

Other macroporous polymeric adsorbents useful in the practice of this invention are copolymers of one or more monoaromatic monomers with one or more nonaromatic monovinylidene monomers. Examples of the latter are methyl acrylate, methyl methacrylate and methylethyl acrylate. When present, these nonaromatic monomers preferably constitute less than about 30% by weight of the copolymer.

The macroporous polymeric adsorbent is prepared by conventional techniques, examples of which are disclosed in various United States patents. Examples are U.S. Pat. Nos. 4,297,220; 4,382,124; 4,564,644; 5,079,274; 5,288,307; 4,950,332; and 4,965,083. The disclosures of each of these patents are incorporated herein by reference in their entirety.

For polymers that are swollen and then crosslinked in the swollen state, the crosslinking subsequent to swelling can be achieved in a variety of ways, which are further disclosed in the patents cited above. One method is to first haloalkylate the polymer, then swell it and crosslink by reacting the haloalkyl moieties with aromatic groups on neighboring chains to form an alkyl bridge. Haloalkylation is achieved by conventional means, an example of which is to first swell the polymer under non-reactive conditions with the haloalkylating agent while including a Friedel-Crafts catalyst dissolved in the haloalkylating agent. Once the polymer is swollen, the temperature is raised to a reactive level and maintained until the desired degree of haloalkylation has occurred. Examples of haloalkylating agents are chloromethyl methyl ether, bromomethyl methyl ether, and a mixture of formaldehyde and hydrochloric acid. After haloalkylation, the polymer is swelled further by contact with an inert swelling agent. Examples are dichloroethane, chlorobenzene, dichlorobenzene, ethylene dichloride, methylene chloride, propylene dichloride, and nitrobenzene. A Friedel-Crafts catalyst can be dissolved in the swelling agent as well, since the catalyst will be used in the subsequent crosslinking reaction. The temperature is then raised to a level ranging from about 60° C. to about 85° C. in the presence of the catalyst, and the bridging reaction proceeds. Once the bridging reaction is complete, the swelling agent is removed by solvent extraction, washing, drying, or a combination of these procedures.

The pore size distribution and related properties of the finished adsorbent can vary widely and no particular ranges are critical to the invention. In most applications, best results will be obtained at a porosity (total pore volume) within the range of from about 0.5 to about 1.5 cc/g of the polymer. A preferred range is about 0.7 to about 1.3 cc/g. Within these ranges, the amount contributed by macropores (i.e., pores having diameters of 500λ or greater) will preferably range from about 0.025 to about 0.6 cc/g, and most preferably from about 0.04 to about 0.5 cc/g. The surface area of the polymer, as measured by nitrogen adsorption methods such as the well-known BET method, will in most applications be within the range of about 150 to about 2100 m²/g, and preferably from about 400 to about 1400 m²/g. The average pore diameter will most often range from about 10 Δ to about 100 Å.

The form of the macroporous polymeric adsorbent is likewise not critical and can be any form which is capable of containment and contact with a flowing compressed air stream. Granular particles and beads are preferred, ranging in size from about 50 to about 5,000 microns, with a range of about 500 to about 3,000 microns particularly preferred. Contact with the adsorbent can be achieved by conventional flow configurations of the gas, such as those typically used in fluidized beds or packed beds. The adsorbent can also be enclosed in a cartridge for easy removal and replacement and a more controlled gas flow path such as radial flow.

The macroporous polymeric adsorbent can function effectively under a wide range of operating conditions. The temperature will preferably be within any range which does not cause further condensation of vapors or any change in physical or chemical form of the adsorbent. Preferred operating temperatures are within the range of from 5° C. to 75° C., and most preferably from 10° C. to 50° C. In general, operation at ambient temperature or between ambient temperature and 10° C. to 15° C. above ambient will provide satisfactory results. The pressure of the natural gas stream entering the adsorbent bed can vary widely as well, preferably extending from 2 psig (115 kPa) to 1000 psig (7000 kPa). The pressure will generally be dictated by the plant unit where the product gas will be used. A typical pressure range is from 100 psig (795 kPa) to 300 psig (2170 kPa). The minimum residence time of the natural gas stream in the adsorbent bed will be 0.02 second and a longer residence time is recommended. The space velocity of the natural gas stream through the bed will most often fall within the range of 0.1 foot per second to 5 feet per second, with a range of 0.3 foot per second to 3 feet per second preferred. Finally, the relative humidity can have any value up to 100%, although a lower relative humidity is preferred.

The crosslinked macroporous polymeric adsorbents of the present invention described herein above can be used to selectively adsorb hydrogen sulfide from natural gas comprising H₂S and one or more other impurities.

The separation process of the present invention comprises passing a natural gas stream comprising H₂S through an adsorber bed charged with the adsorbent(s) of the invention. Preferably, the H₂S which is selectively adsorbed, can be readily desorbed either by lowering the pressure and/or by increasing the temperature of the adsorber bed resulting in a regenerated adsorbent.

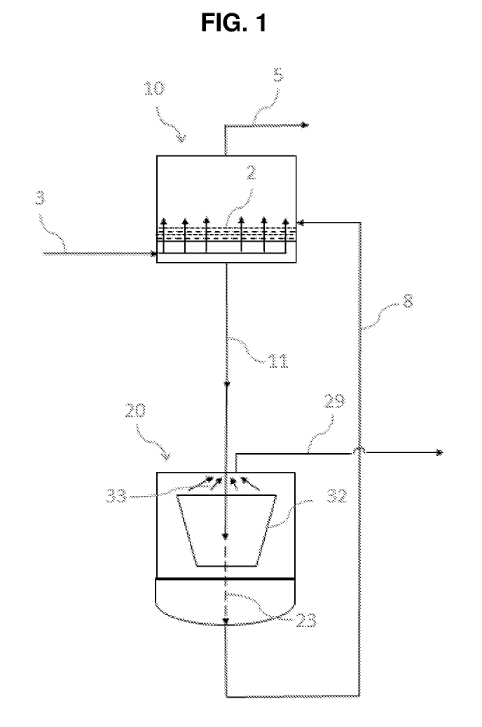

Batch, semi-continuous, and continuous processes and apparatuses for separating H₂S from natural gas feedstreams are well known. FIG. 1 depicts one embodiment of a separation process of the present invention. The separation process comprises the steps of (a) passing a natural gas feedstream 3 through an adsorption unit 10 comprising an adsorbent bed 2 comprising an adsorbent media of the present invention which adsorbs H₂S to obtain a hydrogen sulfide-lean natural gas product which is discharged 5 (recovered, treated further, transported through pipeline or other means, liquefied, flared or the like), (b) transporting 11 adsorbent loaded with H₂S from the adsorption unit 10 to a regeneration unit 20 comprising a means 32 to regenerate the loaded adsorbent media whereby by causing the release of the H₂S 33 from the loaded adsorbing media and forming regenerated adsorbent media 23, (c) wherein the regenerated adsorbent media 23 is transported 8 back to the adsorption unit 10 for reuse, and (d) the released H₂S 33 is discharged 29, (collected, flared, neutralized by caustic, sent to a Claus unit for conversion to elemental sulfur, reinjected, or converted to sulfuric acid, for example via a WSA Process unit).

Although a particular preferred embodiment of the invention is disclosed in FIG. 1 for illustrative purposes, it will be recognized that variations or modifications of the disclosed process lie within the scope of the present invention. For example, in another embodiment of the present invention, there may be multiple adsorbent beds and/or the adsorbent bed(s) may be regenerated in-place as exemplified by U.S. Pat. No. 3,458,973, which is incorporated herein by reference in its entirety.

The adsorption step and/or the regeneration step of the process of the present invention may operate in as a batch process, a semi-continuous process, a continuous process, or combination thereof. For instance in one embodiment of the present invention, both the adsorption step and the regeneration step may operate in the batch mode. In another embodiment of the present invention both the adsorption step and the regeneration step may operate in the semi-continuous mode. In yet another embodiment of the present invention both the adsorption step and the regeneration step may operate in the continuous mode.

Alternatively, in one embodiment of the present invention the adsorption step may operate in a batch, semi-continuous, or continuous mode while the regeneration step operates in a different mode than that of the adsorption step. For example, in one embodiment of the present invention the adsorption step may operate in a batch mode while the regeneration step operates in a continuous mode. In another embodiment of the present invention the adsorption step may operate in a continuous mode while the regeneration step operates in a continuous mode. All possible combinations of batch, semi-continuous, and continuous modes for the adsorbent step and regeneration step are considered within the scope of the present invention.

Adsorption is in many situations a reversible process. The practice of removing volatiles from an adsorption media can be accomplished by reducing the pressure over the media, heating, or the combination of reduced pressure and heating. In either case the desired outcome is to re-volatilize the trapped H₂S, and subsequently remove them from the adsorbent so that it can be reused to capture additional H₂S. Preferably, the adsorption media of the present invention when regenerated, desorbs adsorbed H₂S in an amount equal to or greater than 75 percent of the amount adsorbed, more preferably equal to or greater than 85 percent, more preferably equal to or greater than 90 percent, more preferably equal to or greater than 95 percent, more preferably equal to or greater than 99 percent and most preferably virtually all the H₂S adsorbed.

Traditional means of heating adsorbent media for the purpose of removing adsorbed volatiles that utilize conventional heating systems such as heated gas (air or inert gas), or radiant heat contact exchangers are suitable for use in the present H₂S separation process as part of the adsorbent media regeneration step, for example, by a pressure swing adsorption (PSA) process, a temperature swing adsorption (TSA) process, or a combination thereof. The adsorbent so regenerated can be reused as an adsorbent for the removal of H₂S from the natural gas stream.

Preferably, the H₂S separation process of the present invention employs a microwave heating system as part of the adsorbent media regeneration step. Such a microwave heating system provides a heating system and process for removing H₂S from adsorbent media with higher thermal efficiency at a reduced cost.

One advantage of using a microwave system in conjunction with adsorbents of the present invention is that it allows the microwaves to minimize the heating of the media, but maximize heating of the H₂S to encourage desorption. Such a system has the benefits of being operationally simpler than traditional regeneration systems and reducing the heat effects on the adsorbent material itself. Furthermore, when this desorption process is used in conjunction with a continuous adsorption process such as a moving packed bed or similar device, the H₂S removal can be closely tailored to the composition of the feed. Preferably, the regeneration system for use in the process of the present invention is able to operate in a batch, semi-continuous, or continuous process.

### EXAMPLES

A description of the adsorbent media used in the Examples is as follows.

Adsorbent 1 is a porous cross-linked polymeric adsorbent having a high surface area equal to or greater than 1,000 m²/g made from a macroporous copolymer of a monovinyl aromatic monomer and a crosslinking monomer, where the macroporous copolymer has been post-crosslinked in the swollen state in the presence of a Friedel-Crafts catalyst.

The hydrogen sulfide (H₂S) breakthrough for Adsorbant-1, a cross-linked polymeric adsorbent of the invention, is determined using ultraviolet spectroscopy in the presence of varying levels of carbon dioxide (CO₂). The CO₂ breakthrough is determined using Infrared spectroscopy. Adsorbant-1 is dried in the oven at 70° C. overnight and is loaded in a ⅜ in by 8 ft stainless steel column (3.6 g) and exposed to a nitrogen (N₂) gas stream containing various levels of H₂S and CO₂.

### Examples 1 to 3

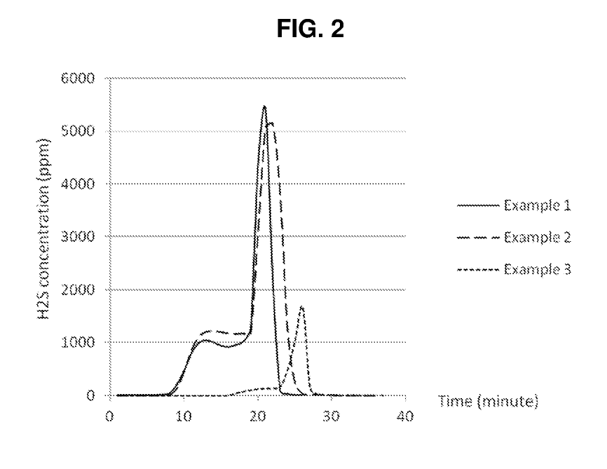

Example 1 comprises 1000 ppm H₂S and 1000 ppm CO₂. Example 2 comprises 1000 ppm H₂S and 1 mol % CO₂. Example 3 comprises 100 ppm H₂S and 1 mol % CO₂. The flow rate is 500 cc/min measured at 25° C. and 1 atm and the back pressure is 75 psig at 25° C. CO₂ breakthrough is observed in 2 min and quickly ramped up to 1000 ppm (Example 1) or 1% (Examples 2 and 3), suggesting very little CO₂ adsorption. When the H2S concentration in the outlet reaches 1000 ppm, the back pressure of the column is released and the column is exposed to N₂ at 500 cc/min at 60° C. until no H₂S is observed in the outlet. The breakthrough curve of the H₂S for Examples 1 to 3 is shown in FIG. 2.

What is claimed is:

1. A process for removing hydrogen sulfide (H₂S) from a natural gas feedstream comprising H₂S comprising the steps of:
(a) providing an adsorbent bed comprising a cross-linked macroporous polymeric adsorbent media, wherein said adsorbent media adsorbs H₂S;
(b) passing the natural gas feedstream through the cross-linked macroporous polymeric adsorbent bed to provide a H₂S-lean natural gas stream and a hydrogen sulfide-loaded cross-linked macroporous polymeric adsorbent media;
(c) further treating, recovering, transporting, liquefying, or flaring the H₂S-lean natural gas stream,
(d) regenerating the loaded cross-linked macroporous polymeric adsorbent media for reuse by desorbing the adsorbed H₂S,
and
(e) discharging the H₂S to be collected, flared, neutralized by caustic, converted to elemental sulfur, reinjected, or converted to sulfuric acid.

2. The process of claim 1 wherein the natural gas stream comprises, in addition to H₂S, one or more impurity wherein the H₂S is selectively removed from the natural gas stream in the presence of one or more impurity.

3. The process of claim 1 wherein the cross-linked macroporous polymeric adsorbent is a polymer of a monovinyl aromatic monomer crosslinked with a polyvinylidene aromatic compound.

4. The process in of claim 3 wherein the monovinyl aromatic monomer comprises from 92% to 99.25% by weight of said polymer, and said polyvinylidene aromatic compound comprises from 0.75% to 8% by weight of said polymer.

5. The process of claim 1 wherein the cross-linked macroporous polymeric adsorbent is a polymer of a member selected from the group consisting of styrene, vinylbenzene, vinyltoluene, ethylstyrene, and t-butylstyrene; and is crosslinked with a member selected from the group consisting of divinylbenzene, trivinylbenzene, and ethylene glycol dimethacrylate.

6. The process of claim 5 wherein the cross-linked macroporous polymeric adsorbent has a total porosity of from 0.5 to 1.5 cc/g, a surface area of from 150 to 2100 m²/g as measured by nitrogen adsorption, and an average pore diameter of from 10 Angstroms to 100 Angstroms.

7. The process of claim 1 wherein the cross-linked macroporous polymeric adsorbent is a polymer of styrene and is crosslinked with divinylbenzene.

8. The process of claim 1 wherein the cross-linked macroporous polymeric adsorbent is a polymer comprising divinylbenzene and optionally ethyl styrene.

9. The process of claim 1 wherein the regeneration of the loaded adsorbent is achieved by using heated gas and/or a radiant heat contact exchanger.

10. The process of claim 1 wherein the regeneration of the loaded adsorbent media is achieved by a using a pressure swing adsorption (PSA) process, a temperature swing adsorption (TSA) process, or a combination thereof.

11. The process of claim 1 wherein the regeneration of the loaded adsorbent media is achieved by a using a microwave heating system.

12. The process of claim 1 wherein the process is continuous.
